(19) United States
(12) Patent Application Publication
(10) Pub. No.: US 2021/0247598 A1
(43) Pub. Date: Aug. 12, 2021

(54) ROTATABLE PROJECTION LENS AND PROJECTOR

(71) Applicant: FUJIFILM Corporation, Tokyo (JP)

(72) Inventor: Yasuto KURODA, Saitama (JP)

(73) Assignee: FUJIFILM Corporation, Tokyo (JP)

(21) Appl. No.: 17/243,595

(22) Filed: Apr. 29, 2021

Related U.S. Application Data
(63) Continuation of application No. 16/361,232, filed on Mar. 22, 2019.
Application No. 16/361,232 is a continuation of application No. PCT/JP2017/029920, filed on Aug. 22, 2017.

(30) Foreign Application Priority Data
Sep. 23, 2016 (JP) 2016-186149

(51) Int. Cl. G02B 17/08; G02B 7/24; G02B 13/16; G02B 17/02; H04N 5/74; G03B 21/28; G02B 7/14; G03B 21/00; G03B 21/14; G02B 23/08

(52) U.S. Cl. CPC G02B 17/08; G02B 7/24; G02B 13/16; G02B 17/023; G02B 23/08; G03B 21/28; G02B 7/14; G03B 21/00; G03B 21/14; H04N 5/74

(57) ABSTRACT

A projection lens is separated into a first optical system that is disposed so as to be closer to an image forming panel and a second optical system that includes a mirror and is disposed so as to be closer to a screen which is a projection surface by the second mirror. The second optical system is set in a first position and a second position by inverting the second optical system around a second optical axis with respect to the first optical system by 180° by an inverting unit. An orientation of a projected image onto the screen is set in the first position and the second position by inverting the image displayed on the image forming panel according to the first position and the second position. It is possible to achieve projection for positioning a center of the screen above or under the optical axis by switching between the first position and the second position.

### CROSS-REFERENCE TO RELATED APPLICATIONS

This is a continuation application of and claims the priority benefit of a prior application Ser. No. 16/361,232 filed on Mar. 22, 2019. The prior application Ser. No. 16/361,232 is a Continuation of PCT International Application No. PCT/JP2017/029920 filed on Aug. 22, 2017, which claims priority under 35 U.S.C. § 119(a) to Japanese Patent Application No. 2016-186149 filed on Sep. 23, 2016. The above application is hereby expressly incorporated by reference, in its entirety, into the present application.

### BACKGROUND OF THE INVENTION

### 1. Field of the Invention

The present invention relates to a projection lens and a projector.

### 2. Description of the Related Art

In recent years, a projector in which an image forming panel such as a liquid crystal display device or a digital micromirror device (DMD) is mounted has come into wide use, and has been improved in performance.

JP2007-264554A describes a liquid crystal projector that irradiates a transmissive liquid crystal panel with light from a light source, enlarges an image displayed on the liquid crystal panel through a projection lens, and projects the enlarged image on a screen surface. The liquid crystal projector of JP2007-264554A includes a reflective member having a reflection surface which reflects video light including a projected video which is incident on a projection optical system which projects a video, and can change an inclined angle of the reflection surface with respect to the video light. Accordingly, it is possible to simply adjust a position of a projected surface on which the video is projected.

A liquid crystal projector of JP2009-217020A can project an optical image emitted from a projection lens in a horizontal direction and a vertical direction without changing a position of a main body of the liquid crystal projector by selectively disposing a minor inclined with respect to an optical axis by 45° in front of the projection lens.

### SUMMARY OF THE INVENTION

In general, in a case where the main body has no lens shift function and a vertical direction of the projector main body is a normal orientation, the projector has a configuration in which a screen center is projected above an optical axis of the projection lens such that an image projected onto a screen is positioned above the projector. Accordingly, in a case where there is an attempt to project the screen center under the optical axis of the projection lens, it is necessary to dispose the projector main body upside down.

Even though a projection direction is switched by using the reflective member as in JP2007-264554A and JP2009-217020A, in a case where there is an attempt to project the screen center under the optical axis of the projection lens, it is necessary to similarly dispose the projector main body upside down.

However, it is necessary to prepare dedicated ceiling hanging equipment in order to dispose the projector main body upside down. An operation switch is present on an upper surface of the projector main body in many cases. Accordingly, in a case where the projector is used in a state in which the projector main body is disposed upside down, the operation switch faces downwards, and thus, it is difficult to perform the operation.

The present invention has been made in view of the circumstances, and an object of the present invention is to provide a projection lens and a projector capable of projecting a screen center toward a side opposite to a normal orientation with respect to an optical axis of the projection lens without disposing a projector main body upside down.

In order to achieve the object, a projection lens of the present invention projects an image on an image forming panel onto a projection surface, and the projection lens is used in a projector in which one of the image forming panel and the projection lens is disposed so as to be shifted in a direction perpendicular to an optical axis. The projection lens comprises a mirror that bends the optical axis, a first optical system, a second optical system, and an inverting unit. The first optical system is disposed closer to the image forming panel than the mirror. The second optical system includes the mirror and is disposed so as to be close to the projection surface. The inverting unit selectively holds the second optical system in a first position and a second position, which is inverted from the first position by 180°, around the optical axis with respect to the first optical system.

It is preferable that the mirror is provided in plural, and the mirror that separates the first optical system and the second optical system is the mirror closest to an emission side which is disposed so as to be closest to the projection surface on the optical axis.

It is preferable that the inverting unit comprises a sensor that detects the first position and the second position. It is preferable that the inverting unit has position indices that display the first position and the second position. It is preferable that the inverting unit switches the second optical system between the first position and the second position by rotationally moving the second optical system around the optical axis with respect to the first optical system. It is preferable that the inverting unit includes a click mechanism that fixes the second optical system to the first position and the second position.

It is preferable that the projection lens includes a light shielding unit. The light shielding unit shields light from the image forming panel in a non-detection state in which the second optical system is disposed in neither the first position nor the second position and the sensor is turned off.

A projector of the present invention comprises the projection lens, an image forming panel that displays an image, a light source that illuminates the image forming panel, a casing, and an image display inverting unit. The casing accommodates the image forming panel in a state in which one of the image forming panel and the projection lens is shifted in a direction perpendicular to the optical axis. The image display inverting unit inverts the image based on a signal of the sensor such that an orientation of a projected image of the projection surface is set in the first position and the second position in line with the switching of the second optical system between the first position and the second position.

It is preferable that the projector includes a light shielding unit. The light shielding unit shields light from the image forming panel in a non-detection state in which the second optical system is disposed in neither the first position nor the second position and the sensor is turned off. The light shielding unit may be provided within the projection lens, or may be provided between the projection lens and the image forming panel. It is preferable that the projection lens is attached to the casing so as to be attachable and detachable.

According to the present invention, it is possible to provide a projection lens and a projector capable of projecting a screen center toward a side opposite to a normal orientation with respect to an optical axis of the projection lens without disposing a projector main body upside down.

### BRIEF DESCRIPTION OF THE DRAWINGS

FIG. 1 is a perspective view showing a projector of the present invention.

FIG. 2 is a longitudinal sectional view of the projector.

FIG. 3 is a cross-sectional view of main components taken along line in FIG. 2 showing an inverting unit.

FIG. 4 is a longitudinal sectional view showing rear-surface upward projection in a rear-surface projection position which is a first position.

FIG. 5 is a longitudinal sectional view showing front-surface downward projection in a front-surface projection position which is a second position.

FIG. 6 is a cross-sectional view of main components showing a click mechanism.

FIG. 7 is a flowchart showing a procedure for image display inverting control and control of a light shielding unit using a controller.

FIG. 8 is a plan view showing a projector of a second embodiment using one mirror.

FIG. 9 is a side view of the projector of the second embodiment.

FIG. 10 is a front view of the projector of the second embodiment in the first position.

FIG. 11 is a front view of the projector of the second embodiment in the second position.

FIG. 12 is a cross-sectional view of main components of a third embodiment in a state in which the second optical system is switched to the first position through fitting.

FIG. 13 is a cross-sectional view of main components of a third embodiment in a state in which the second optical system is switched to the second position through fitting.

FIG. 14 is a plan view of main components showing a reference index and position indices.

### DESCRIPTION OF THE PREFERRED EMBODIMENTS

[First Embodiment]

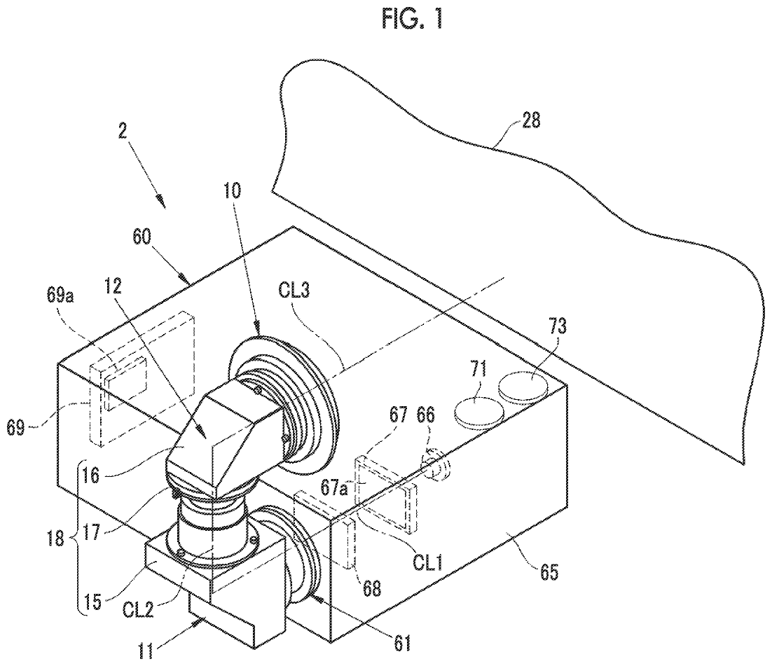

As shown in FIG. 1, a projector 2 of the present embodiment comprises a projection lens 10 and a projector main body 60. FIG. 1 shows a case where the projector 2 is disposed on a horizontal plane such as a table.

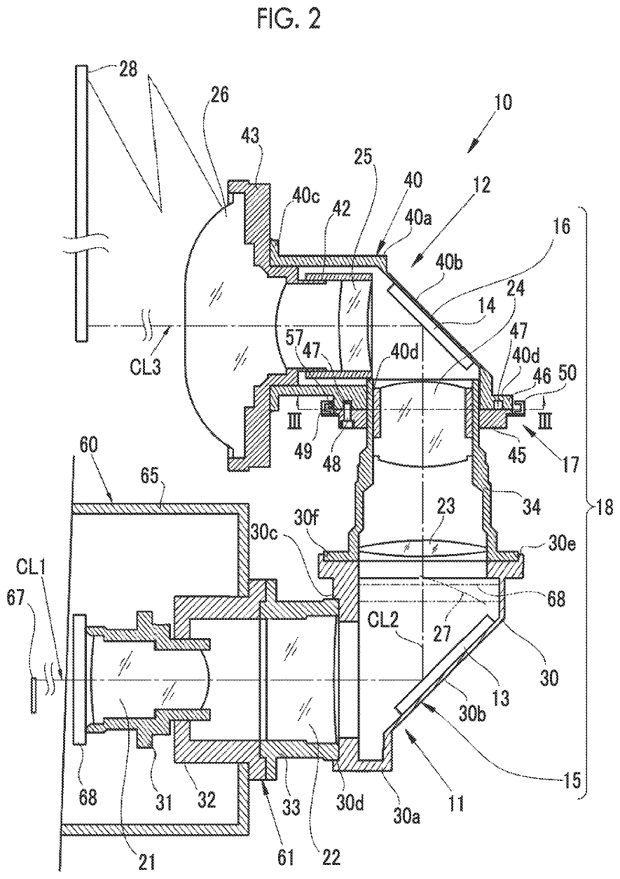

As shown in FIG. 2, the projection lens 10 comprises a first optical system 11, a second optical system 12, a first mirror 13, a second mirror 14, a first holding member 15, a second holding member 16, and an inverting unit 17. The first holding member 15, the second holding member 16, and the inverting unit 17 constitute a lens barrel 18.

The first optical system 11 is constituted by a first lens 21, a second lens 22, a third lens 23, a fourth lens 24, and the first mirror 13. The first lens 21, the second lens 22, and the fourth lens 24 are displayed as a single lens for simplicity of illustration, but are constituted by a plurality of lens groups in reality. The first lens 21 and the second lens 22 fauns an intermediate image on an imaging surface 27 by using illumination light from an image forming panel 67.

The first mirror 13 is disposed between the second lens 22 and the third lens 23. The first mirror 13 forms a second optical axis CL2 crossing the first optical axis CL1 at 90° by bending a first optical axis CL1 of the first lens 21 and the second lens 22 by reflection.

The first holding member 15 includes a first main body 30, a first lens frame 31, a first attachment sleeve 32, a second attachment sleeve 33, and a third attachment sleeve 34. The first holding member 15 integrally holds the first lens 21 to the fourth lens 24 and the first mirror 13. The first main body 30 is constituted by an approximately rectangular parallelepiped square tube. One corner portion of a lower plate 30a of the first main body 30 is obliquely cut, and thus, an inclined surface portion 30b is formed. The first mirror 13 is fixed onto an inner surface of the inclined surface portion 30b.

A first attachment hole 30d of the first optical system 11 is formed in a front plate 30c on an entrance side facing the inclined surface portion 30b. One end of the second attachment sleeve 33 is fixed to the first attachment hole 30d. The second attachment hole 30f is formed in an upper plate 30e of the first main body 30. A lower end portion of the third attachment sleeve 34 is fixed to the second attachment hole 30f. The third attachment sleeve 34 holds third lens 23 and the fourth lens 24 according to the second optical axis CL2.

The second optical system 12 is constituted by the second mirror 14, a fifth lens 25, and a sixth lens 26. The second mirror 14 is disposed between the fourth lens 24 and the fifth lens 25. The second mirror 14 forms a third optical axis CL3 crossing the second optical axis CL2 by 90° by bending the second optical axis CL2 by reflection. The fifth lens 25 and the sixth lens 26 are displayed as a single lens for simplicity in illustration, but are constituted by a plurality of lens groups in reality. The third lens 23 to the sixth lens 26 project the intermediate image formed on the imaging surface 27 by the first lens 21 and the second lens 22 onto, for example, a screen 28 which is a projection target.

The second holding member 16 includes a second main body 40, a second lens frame 42, and a third lens frame 43. The second holding member 16 integrally holds the fifth lens 25, the sixth lens 26, and the second mirror 14. The second main body 40 is constituted by an approximately rectangular parallelepiped square tube. One corner portion of an upper plate 40a of the second main body 40 is obliquely cut, and thus, an inclined surface portion 40b is formed. The second mirror 14 is fixed onto an inner surface of the inclined surface portion 40b.

An attachment flange 40c is formed on an end surface facing the inclined surface portion 40b of the second main body 40 in a horizontal direction. The third lens frame 43 is fixed to the attachment flange 40c. The second lens frame 42 is attached to one end of the third lens frame 43 so as to be movable in a direction of the third optical axis CL3. The fifth lens 25 is fixed to the second lens frame 42, and the sixth lens 26 is fixed to the third lens frame 43. The second lens frame 42 is moved along the third optical axis CL3 by a lens movement mechanism (not shown), and adjusts a focus.

The lens configurations of the first lens 21 to the sixth lens 26 are described in detail in “projection optical system and projection display device” such as Japanese Patent Application No. 2015-035085 (corresponding to US 2016/246037 A1) and Japanese Patent Application No. 2015-045989, and the optical systems described in these documents can be used as the first optical system 11 and the second optical system 12. According to the projection optical system and the projection display device, an optical system having high projection performance of which various aberrations are corrected in a wide angle is favorably obtained.

In the present embodiment, the first optical axis CL1 of the first lens 21 and the second lens 22 is reflected by the first mirror 13 and is bent at 90°, and thus, the second optical axis CL2 is formed. The second optical axis CL2 of the third lens 23 and the fourth lens 24 is reflected by the second mirror 14 and is bent at 90°, and thus, the third optical axis CL3 on an emission side is formed. The third optical axis CL3 is parallel to the first optical axis CL1 within a plane including the first optical axis CL1 and the second optical axis CL2.

The inverting unit 17 is disposed between an upper end portion of the third attachment sleeve 34 and a lower plate 40d of the second main body 40. The inverting unit 17 includes a first flange 45, a second flange 46, a circumferential groove 47, a guide pin 48, a first sensor 49, and a second sensor 50. The first flange 45 is formed in a disc shape on an outer circumferential surface of the upper end portion of the third attachment sleeve 34. The second flange 46 is formed in a disc shape on the lower plate 40d of the second main body 40.

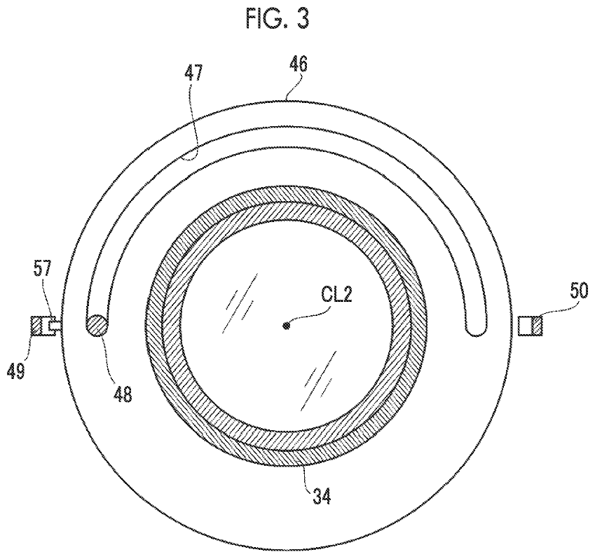

As shown in FIG. 3, the circumferential groove 47 is a groove having a semicircular arc groove with the second optical axis CL2 as a center, and is formed on a lower surface of the second flange 46. As shown in FIG. 2, the guide pin 48 is formed in parallel with the second optical axis CL2 so as to protrude from an upper surface of the first flange 45. A front end of the guide pin 48 is inserted into the circumferential groove 47 in a state in which the first flange 45 and the second flange 46 are combined together. As shown in FIG. 3, the circumferential groove 47 is formed in an angle range of 180° with the second optical axis CL2 as a center. Accordingly, the guide pin 48 guided to the circumferential groove 47 is movable within a length range of the circumferential groove 47. Accordingly, the rotational movement of the second optical system 12 including the second main body 40 with respect to the first optical system 11 including the third attachment sleeve 34 is allowed at an angle of 180°, and thus, the second optical system can be inverted.

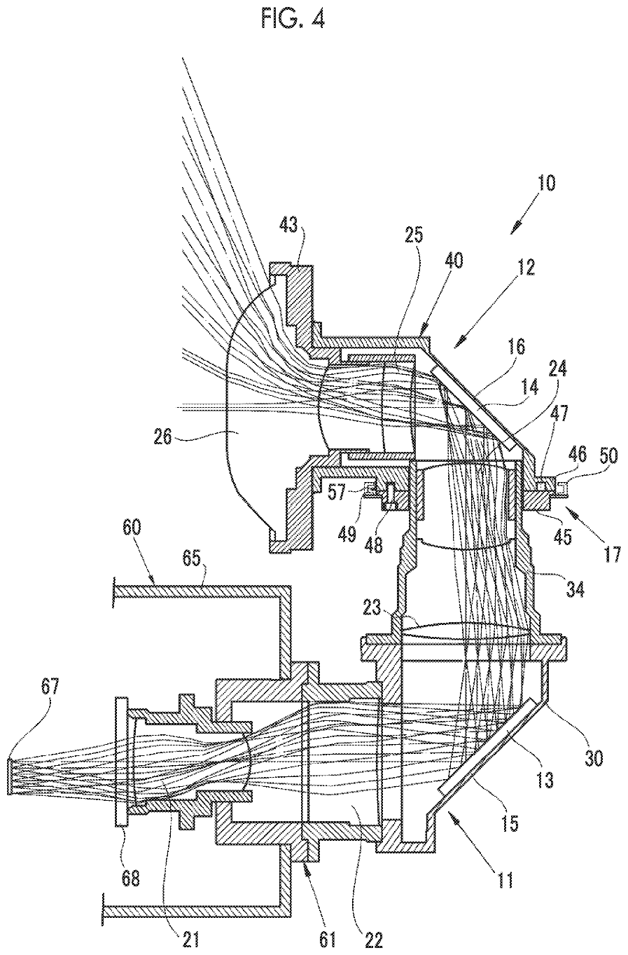

In a case where the guide pin 48 is positioned in one end portion of the circumferential groove 47 as shown in FIG. 3, the second optical system is positioned in a rear-surface projection position (corresponding to a first position) in which the sixth lens 26 of the second optical system 12 faces a rear surface as shown in FIG. 4. An image is projected so as to face the rear surface in the rear-surface projection position by the second optical system 12. The image reflected in the screen 28 is projected onto a portion higher than the third optical axis CL3, and so-called upward projection is achieved.

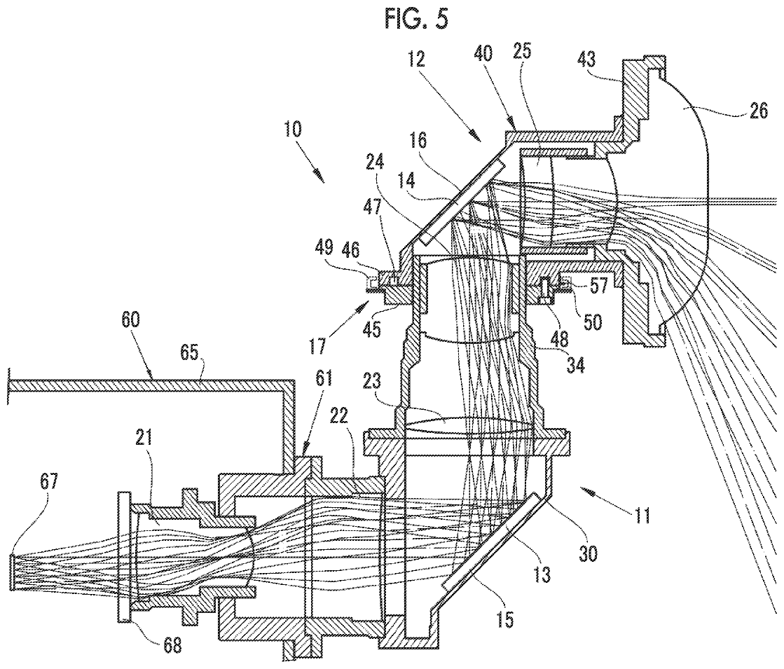

Meanwhile, in a case where the second optical system 12 is inverted from the rear-surface projection position by 180° and the guide pin 48 is positioned at the other end portion of the circumferential groove 47, the second optical system 12 is positioned in a front-surface projection position (corresponding to a second position) in which the sixth lens 26 faces a front surface, as shown in FIG. 5. The image is projected so as to face the front surface in the front-surface projection position by the second optical system 12. The image reflected in the screen 28 is projected on a portion lower than the third optical axis CL3, and so-called downward projection is achieved.

As shown in FIGS. 2 and 3, the first sensor 49 and the second sensor 50 are attached to the first flange 45 in order to detect an orientation of the second optical system 12. For example, a photo-interrupter is used as the first sensor 49 and the second sensor 50. An L-shaped sensor plate 57 protruding in a radial direction is attached to an outer circumferential surface of the second flange 46. The sensor plate 57 shields detection light rays of the first sensor 49 or the second sensor 50, and thus, the first sensor 49 and the second sensor 50 are turned on. In a case where the first sensor 49 is turned on, it is detected that the second optical system 12 is set in the rear-surface projection position. In a case where the second sensor 50 is turned on, it is detected that the second optical system 12 is set in the front-surface projection position. Meanwhile, in a case where the second optical system 12 is positioned in neither the rear-surface projection position nor the front-surface projection position, the first sensor 49 and the second sensor 50 are turned off. Hereinafter, this state is referred to as a non-detection state.

Signals of the first sensor 49 and the second sensor 50 are sent to a controller 69 of the projector main body 60 through a mount unit 61 to be described below. Since the sensors 49 and 50 are attached to the first flange 45 on a fixed side at the time of inverting the second optical system, wiring for the sensors 49 and 50 is easier than wiring in a case where the sensors 49 and 50 are attached to the second flange 46.

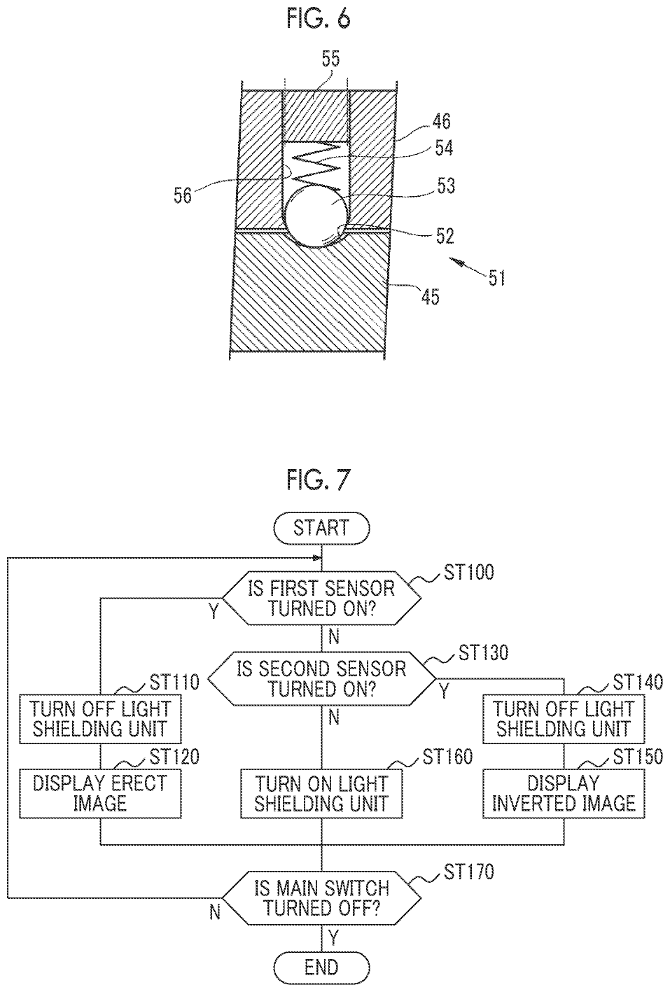

As shown in FIG. 6, a click mechanism 51 is provided on a combined surface of the first flange 45 and the second flange 46. The click mechanism 51 includes a locking hole 52, a locking ball 53, a coil spring 54, and a spring suppression screw 55, and positions the second optical system 12 in the rear-surface projection position and the front-surface projection position. The locking hole 52 is a spherical recess, and is formed in positions of the combined surface of the first flange 45 which correspond to the rear-surface projection position and the front-surface projection position. The spring suppression screw 55 is screwed to a locking ball accommodation hole 56, and holds the locking ball 53 and the coil spring 54 in the locking ball accommodation hole 56. The locking ball 53 is biased so as to come in contact with the combined surface of the first flange 45 by the coil spring 54.

The first holding member 15 and the second holding member 16 are individually assembled. As shown in FIG. 2, the first holding member 15 and the second holding member 16 are joined through the inverting unit 17 in a state in which the second optical axis CL2 on the emission side of the first optical system 11 and the second optical axis CL2 on an incidence side of the second optical system 12 are together, and thus, the lens barrel 18 is assembled. In the lens barrel 18 assembled in this manner, a U-shaped optical path is formed by the second optical axis CL2, the first optical axis CL1 on the incidence side of the first optical system 11, which has an angle of 90° with respect to the second optical axis CL2, and the third optical axis CL3 on the emission side of the second optical system 12.

As shown in FIG. 1, the projection lens 10 is attached to the projector main body 60 through the mount unit 61 so as to be attachable and detachable. The projector main body 60 includes an approximately rectangular parallelepiped casing 65. A light source 66, the image forming panel 67, a light shielding unit 68, and the controller 69 are accommodated within the casing 65.

For example, a transmissive liquid crystal panel is used as the image forming panel 67. The light source 66 is disposed on a rear surface of the image forming panel 67, that is, a side opposite to the projection lens 10 with the image forming panel 67 as a reference. Light-emitting diodes (LEDs) that simultaneously emit three colors of red (R), green (G), and blue (B) are used as the light source 66, and illuminates the image forming panel 67. A xenon lamp, a halogen lamp, or an extra-high pressure mercury lamp which emits white light may be used instead of the LEDs. The projection lens 10 projects the illumination light from the image forming panel 67 illuminated by the light source 66 onto a projection surface, for example, the screen 28.

For example, the light shielding unit 68 is disposed between the image forming panel 67 and the first lens 21. The light shielding unit 68 is used for selectively inserting a mechanical shutter which opens and closes a shutter or an ND filter into an optical path. A state of projection light is switched between a light shielding state in which the projection light from the image forming panel 67 and a transmission state in which the projection light is transmitted by the light shielding unit 68. As shown in a dashed double-dotted line in FIG. 2, the light shielding unit 68 may be provided in the projection lens 10 instead of being provided in the projector main body 60.

The controller 69 turns on the light source 66, and displays an image of three RGB colors on an image forming surface 67a which is a surface of the image forming panel 67 on a side opposite to a surface facing the light source 66. The controller 69 includes an image display inverting unit 69a. The image display inverting unit 69a controls the inverting of the image based on stoppage position signals for the second optical system 12 from the sensors 49 and 50. In a case where the first sensor 49 is turned on and the second optical system 12 is in the rear-surface projection position and enters a rear-surface upward projection state, the controller displays a normal image (an erect image) on the image forming panel 67. In a case where the second optical system 12 is in a front-surface projection position and enters a front-surface downward projection state, the controller displays an inverted image acquired by inverting the image upside down on the image forming panel 67.

In the non-detection state in which the second optical system 12 is disposed in neither the rear-surface projection position nor the front-surface projection position and the first sensor 49 and the second sensor 50 are turned off, the controller 69 shields the projection light from the image forming panel 67 by operating the light shielding unit 68. Meanwhile, in a state other than the non-detection state, the controller 69 sets the projection light from the image forming panel 67 in the transmission state by operating the light shielding unit 68.

FIG. 7 is a flowchart showing a procedure for image display inverting control and the control of the light shielding unit 68 using the controller 69 based on the signals of the first sensor 49 and the second sensor 50. In a case where the first sensor 49 is turned on (Y in step ST100, in a case where the second optical system 12 is disposed in the rear-surface projection position which is the first position), the controller 69 sets the projection light from the image forming panel 67 in the transmission state by operating the light shielding unit 68 (step ST110), and displays the erect image by controlling the image display inverting unit 69a (step ST120). Accordingly, as shown in FIG. 4, the image is projected onto the portion of the screen 28 higher than the third optical axis CL3, and the so-called upward projection is achieved.

Meanwhile, in a case where the second sensor 50 is turned on (Y in step ST130, in a case where the second optical system 12 is disposed in the front-surface projection position which is the second position), the controller 69 sets the projection light from the image forming panel 67 in the transmission state by operating the light shielding unit 68 similarly to step ST110 (step ST140), and displays the inverted image by controlling the image display inverting unit 69a (step ST150). Accordingly, as shown in FIG. 5, the image is projected onto the portion of the screen 28 lower than the third optical axis CL3, and the so-called downward projection is achieved. As stated above, an orientation of the projected image onto the screen 28 is switched so as to be set in the rear-surface projection position or the front-surface projection position based on the signals of the first sensor 49 and the second sensor 50 by the image display inverting unit 69a in line with the switching of the second optical system 12 between the rear-surface projection position and the front-surface projection position.

In a case where the first sensor 49 and the second sensor 50 are turned off, that is, in the non-detection state (N in both step ST100 and step ST130), since the second optical system 12 is rotationally moving, the controller 69 shields the projection light from the image forming panel 67 by operating the light shielding unit 68 (step ST160). In this state, the projection light from the image forming panel 67 is shielded by the light shielding unit 68, the image is not projected from the second optical system 12. Hereinafter, while a main switch is turned on (N in step ST170), the processes are repeated. In a case where the main switch is turned off (Y in step ST170), the control is ended.

The controller 69 also performs the following processes. For example, in a case where the projection lens 10 has an electric zoom control function and an operation signal for a zoom dial 71 (see FIG. 1) is received, a size of the image projected onto the screen 28 is adjusted. In a case where an operation signal for a focus dial 73 (see FIG. 1) is received, the controller 69 adjusts a focus of the image projected onto the screen 28 by operating a focus adjustment mechanism (not shown) of the projection lens 10.

As shown in FIG. 2, the image forming panel 67 is disposed so as to be shifted downwards from the first optical axis CL1. For example, the image is displayed under the first optical axis CL1. In contrast, the image projected through the first optical system 11 and the second optical system 12 is displayed on the screen 28 so as to be shifted above the third optical axis CL3. Accordingly, as shown in FIG. 4, the image is projected onto the screen 28 disposed on a rear side so as to be higher than the third optical axis CL3 in the rear-surface projection position.

In a case where there is an attempt to project the image under the third optical axis CL3, the second optical system 12 is rotated (inverted) around the second optical axis CL2 by 180° by using the second main body 40. Accordingly, as shown in FIG. 5, the sixth lens 26 faces a front side. In this state, the downward projection in which the image projected on the screen 28 is positioned under the third optical axis CL3 is achieved due to the reflection using the second mirror 14.

As stated above, it is possible to simply switch between the upward projection and the downward projection by a simple operation for rotating the second optical system 12 around the second optical axis CL2 by 180° without inverting the projector main body 60 upside down. In this switching, the image displayed on the image forming panel 67 is inverted upside down by the image display inverting unit 69a. Accordingly, the orientation of the image after the switching may not be inverted upside down.

Since the projection light is shielded by the light shielding unit 68 in the non-detection state which the switching is being performed, the projection light is not projected from the projection lens 10 being moved rotationally, and it is possible to eliminate discomfort during the switching. Since the second optical system 12 is positioned in the rear-surface projection position and the front-surface projection position by the click mechanism 51, it is possible to reliably invert the second optical system 12.

Various inverting guide mechanisms can be used as the inverting unit 17 as long as the inverting guide mechanism can rotate the third attachment sleeve 34 and the second main body 40 around the second optical axis CL2 by 180°. For example, the second optical system 12 is inverted by forming a circumferential groove in an outer circumferential surface of the third attachment sleeve 34, forming a guide pin inserted into the circumferential groove in an inner circumferential surface of an attachment hole of the second main body 40 to which the third attachment sleeve 34 is attached, and regulating the movement of the guide pin by using the circumferential groove. Although the second optical system 12 is manually inverted, the second optical system may be automatically inverted by providing a rotational movement gear integrally with the second flange 46 and rotating this rotational movement gear by a motor. In this case, a switch for switching between the positions of the second optical system 12 by driving the motor is provided at the casing 65.

[Second Embodiment]

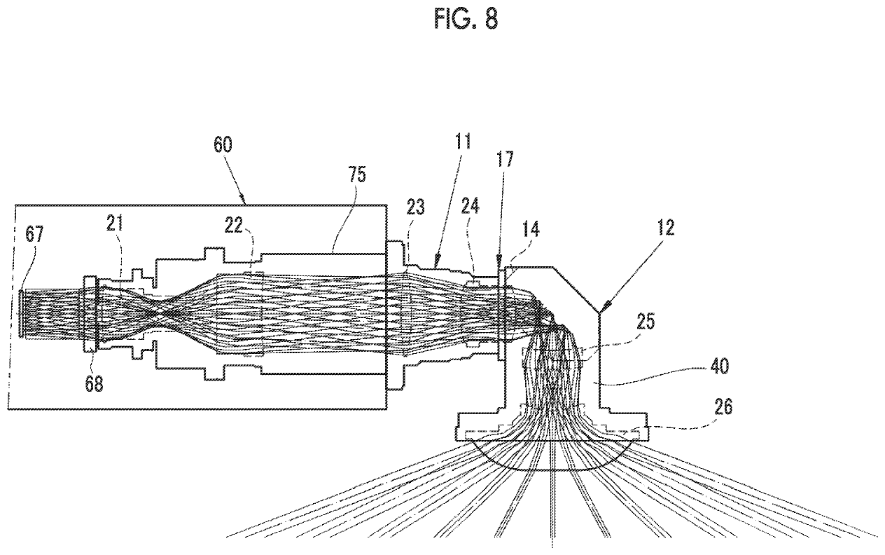

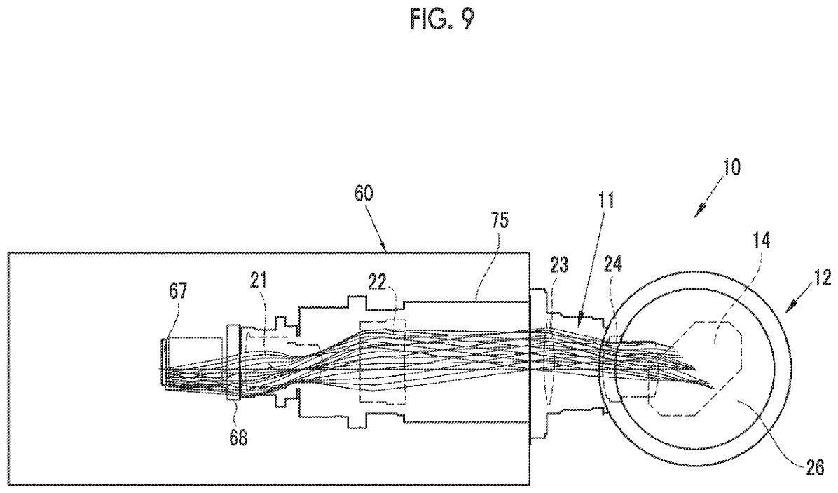

Two mirrors 13 and 14 are used in the first embodiment. In a second embodiment shown in FIGS. 8 to 11, the first mirror 13 is removed, only the second mirror 14 is used, and the optical axis has an L shape. In this second embodiment, a cylindrical first main body 75 is provided instead of the first main body 30 of the first embodiment which is the approximately rectangular parallelepiped square tube. The first main body 75 is accommodated in the projector main body 60. The second mirror 14 forms the second optical axis CL2 by bending the first optical CL1 (not shown) of the first lens 21 and the second lens 22. The second embodiment has the same configuration as the first embodiment except that the first mirror 13 of the first embodiment is removed and the first main body 75 has the cylindrical shape. In the following embodiment, the same components as those of the first embodiment will be assigned the same references, and the redundant description thereof will be omitted.

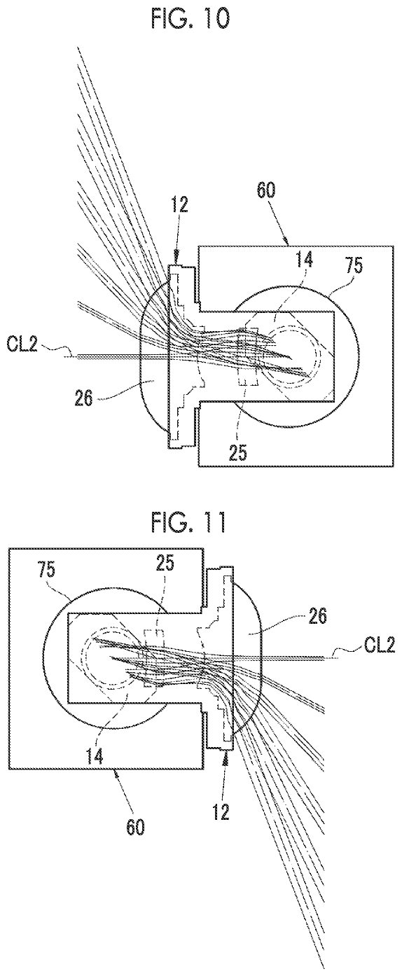

In the second embodiment, the second optical system 12 can be rotated around the first optical system 11 by 180° by the inverting unit 17 as in the first embodiment by using one mirror 14. Accordingly, the upward projection for displaying the image above the second optical axis CL2 as shown in FIG. 10 and the downward projection for displaying the image under the second optical axis CL2 as shown in FIG. 11 can be achieved. In the second embodiment, the position of the second optical system 12 shown in FIG. 10 corresponds to the first position, and the position of the second optical system 12 shown in FIG. 11 corresponds to the second position. According to the second embodiment, it is possible to project a screen center toward a side opposite to a normal orientation with respect to the optical axis CL3 without disposing the projector main body 60 upside down.

[Third Embodiment]

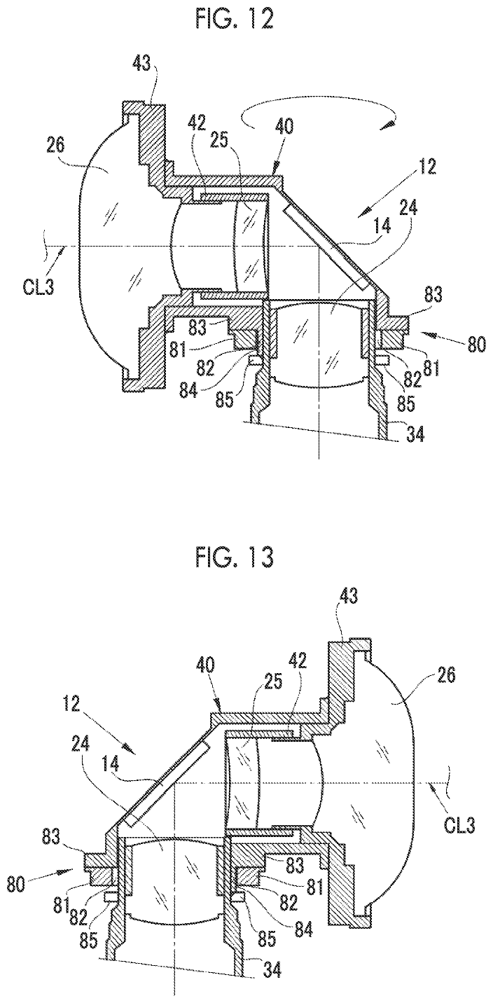

Although the inverting unit 17 for rotating the second optical system 12 is used in a state in which the second optical system 12 is connected to the first optical system 11 in the first and second embodiments, an inverting unit 80 using a fitting method is used in a third embodiment shown in FIGS. 12 and 13. The inverting unit 80 includes two key grooves 82 and one key protrusion 84. The key grooves 82 are formed in the first flange 81 of the first optical system 11 in parallel to the second optical axis CL2 in positions spaced apart from each other by 180° in a circumferential direction. The key protrusion 84 is a columnar protrusion extending in parallel with the second optical axis CL2. The key protrusion 84 protrudes downwards from a lower surface of the second flange 83 formed on the second main body 40, and is disposed on an outer circumference of the third attachment sleeve 34.

In a case where the second optical system 12 is assembled to the first optical system 11, the key protrusion 84 is inserted into one key groove 82 or the other key groove 82, and thus, it is possible to switch between the fitting positions of the second optical system 12 with respect to the first optical system 11 as shown in FIGS. 12 and 13. Key sensors 85 are attached to the third attachment sleeve 34 in positions corresponding to the key grooves 82. The key sensor 85 is, for example, a limit switch, and detects the key protrusion 84. The key sensor 85 can detect whether the second optical system 12 is in the first position or the second position. In the third embodiment, the position of the second optical system 12 shown in FIG. 12 corresponds to the first position, and the position of the second optical system 12 shown in FIG. 13 corresponds to the second position. According to the third embodiment, it is possible to project the screen center toward the side opposite to the normal orientation with respect to the optical axis CL3 without disposing the projector main body 60 upside down.

Although one mirror 14 or the two mirrors 13 and 14 are used in the embodiments, the number of mirrors may be three or more. In this case, the projection lens is separated into the first optical system 11 and the second optical system 12 by the mirror closest to the emission side which is disposed so as to be closest to the screen 28 which is the projection surface on the optical axis. However, the mirror closest to the emission side in the first embodiment is the second mirror 14.

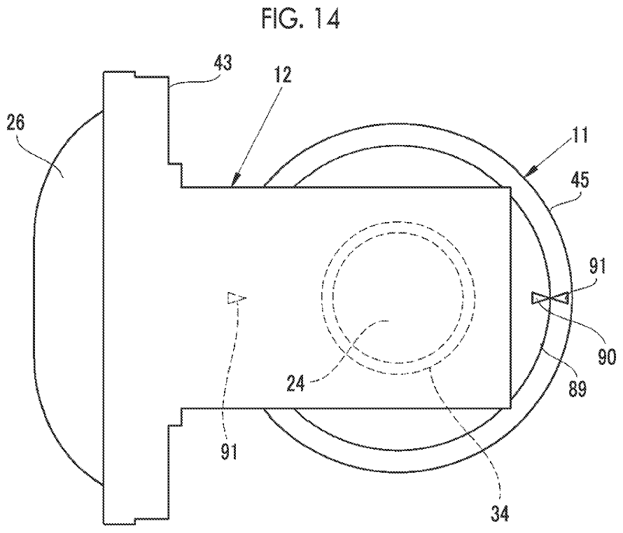

In the first embodiment, the second optical system 12 is selectively stopped in the rear-surface projection position which is the first position and the front-surface projection position which is the second position by using the click mechanism 51 in the first embodiment. Instead of or in addition to the aforementioned positioning method of the second optical system, the second optical system 12 may be positioned in the first position and the second position by using a reference index 90 and position indices 91 as shown in FIG. 14. The reference index 90 is formed at an outer circumferential portion on an upper surface of a second flange 89 formed on the second main body 40. The second flange 89 is formed so as to have an outer diameter smaller than the second flange 46 of the first embodiment. Accordingly, an outer circumferential portion of the first flange 45 is exposed from an outer circumference of the second flange 89 in plan view. The position index 91 is formed on the upper surface of the exposed outer circumferential portion of the first flange 45. The position index 91 is connected to the reference index 90 in a straight line in a case where the second optical system is in the first position and the second position. Accordingly, the position index 91 matches the reference index 90 by rotationally moving the second optical system 12, and thus, it is possible to selectively position the second optical system 12 in the first position and the second position with respect to the first optical system 11.

Although the transmissive liquid crystal panel is used as the image forming panel 67 in the embodiments, a reflective liquid crystal panel may be used. In this case, the light source 66 is disposed on the front side of the image forming panel 67, and the irradiation light rays of three RGB colors are simultaneously irradiated. In a case where the DMD is used as the image forming panel 67, the light source 66 is disposed on the front side of the image forming panel 67, and LEDs of three RGB colors are emitted in time division in synchronization with a forming timing of a three-color image of the DMD.

Although it has been described in a state in which the projector 2 is disposed on the table in the embodiments, the present invention is also applicable to a case where the projector 2 hung from a ceiling is used. Although it has been described that the image is projected onto the screen 28, the projection surface is not limited to the screen 28. A projector that projects the image onto various projection surfaces can be used.

It has been described in the embodiments that the terms of perpendicular and parallel are used for expressing the positional relationship between the plurality of optical axes or the specific numerical angle such as 90° is used. However, these terms and numerical angle include a range allowable within an error corresponding to accuracy required in the optical system.

Although the projector 2 including the exchangeable projection lens 10 through the mount unit 61 is described in the first embodiment, the projection lens 10 is also applicable to a projector fixed to the projector main body 60. For example, in a case where the exchangeable projection lens 10 is used, some lenses of the first optical system 11, for example, the first lens 21 and the second lens 22 may be provided in the projector main body, and the number of lenses on the projection lens 10's side may be reduced.

Although the image forming panel 67 is shifted under the first optical axis CL1 in the first embodiment, the image forming panel may be shifted above the first optical axis. The target shifted in a direction perpendicular to the first optical axis CL1 may be the projection lens 10 instead of the image forming panel 67, or both the image forming panel 67 and the projection lens 10 may be shifted and arranged.

### Explanation of References

2: projector

10: projection lens

11: first optical system

12: second optical system

13: first mirror

14: second mirror

15: first holding member

16: second holding member

17: inverting unit

18: lens barrel

21: first lens

22: second lens

23: third lens

24: fourth lens

25: fifth lens

26: sixth lens

27: imaging surface

28: screen

30: first main body

30a: lower plate

30b: inclined surface portion

30c: front plate

30d: first attachment hole

30e: upper plate

30f: second attachment hole

31: first lens frame

32: first attachment sleeve

33: second attachment sleeve

34: third attachment sleeve

40: second main body

40a: upper plate

40b: inclined surface portion

42: second lens frame

43: third lens frame

45: first flange

46: second flange

47: circumferential groove

48: guide pin

49: first sensor

50: second sensor

51: click mechanism

52: locking hole

53: locking ball

54: coil spring

55: spring suppression screw

56: locking ball accommodation hole

57: sensor plate

60: projector main body

61: mount unit

65: casing

66: light source

67: image forming panel

67a: image forming surface

68: light shielding unit

69: controller

69a: image display inverting unit

71: zoom dial

73: focus dial

75: first main body

80: inverting unit

81: first flange

82: key groove

83: second flange

84: key protrusion

85: key sensor

89: second flange

90: reference index

91: position index

CL1: first optical axis

CL2: second optical axis

CL3: third optical axis

ST100 to ST170: step

What is claimed is:

1. A projector comprising:
an image forming panel that displays an image;
a projection lens that projects a projection image of the image onto a projection surface, the projection lens comprising:
a first mirror;
a second mirror bending a light from the first mirror;
a first optical system that includes a first optical axis, the first minor, and a second optical axis along to a vertical direction, and is disposed closer to the image forming panel than the second mirror in an optical path;
a second optical system that includes an emission lens, a third optical axis, and the second mirror, and is disposed closer to the projection surface than the first optical system in the optical path; and
an inverting mechanism that moves a position of the second optical system from a first position to a second position, which is inverted from the first position by 180° in a horizontal direction, around the second optical axis with respect to the first optical system,
wherein the emission lens includes a first area which is an area located upper than the third optical axis in a side view, and a second area which is an area located lower than the third optical axis in the side view,
wherein a center of the image forming panel is disposed so as to be shifted in a direction perpendicular to the first optical axis,
wherein the second optical system projects the projection image towards upper than the third optical axis at the first position by shifting the image &Lining panel to the first optical axis, so that the projection image is projected through substantially the first area only, and
wherein the second optical system projects the projection image towards lower than the third optical axis at the second position by shifting the image forming panel to the first optical axis, so that the projection image is projected through substantially the second area only.

2. The projector according to claim 1,
wherein the first optical system doesn't invert with respect to a projector body of the projector.

3. The projector according to claim 1,
wherein a lower edge of the projection image at the first position is substantially at a same height with an upper edge of the projection image at the second position.

4. The projector according to claim 1,
wherein the second optical system includes the second mirror closest to an emission side which is disposed so as to be closest to the projection surface on the optical path.

5. The projector according to claim 1,
wherein the inverting mechanism comprises a sensor that detects the first position and the second position.

6. The projector according to claim 5,
wherein the inverting mechanism has position indices that display the first position and the second position.

7. The projector according to claim 5,
wherein the inverting mechanism switches the second optical system between the first position and the second position by rotationally moving the second optical system around the second optical axis with respect to the first optical system.

8. The projector according to claim 7,
wherein the inverting mechanism includes a click mechanism,
wherein the click mechanism includes a locking ball, a spring and a locking hole, and
wherein the locking ball is biased by the spring in the locking hole at the first position and the second position.

9. The projector according to claim 5 further comprising:
a light shielding unit that shields light from the image forming panel in a non-detection state in which the second optical system is disposed in neither the first position nor the second position and the sensor is turned off.

10. The projector according to claim 1,
wherein a lens disposed closest to the projection surface among a plurality of lenses arranged in the first optical system and the second optical system has the largest diameter and projects from a projector body of the projector.

11. The projector according to claim 1,
wherein the inverting mechanism comprises a sensor that detects the first position and the second position,
wherein the projection lens further comprises a third optical system that is disposed closer to the image forming panel than the first mirror,
wherein when the second optical system is disposed on the first position, the second optical system is disposed at a same side with the third optical system respect to the first optical system in a side view, and
wherein when the second optical system is disposed on the second position, the second optical system is disposed at an opposite side with the third optical system respect to the first optical system in the side view.

12. The projector according to claim 1 further comprising:
a light source that illuminates the image forming panel;
a casing that accommodates the image forming panel in a state in which one of the image forming panel and the projection lens is shifted in a direction perpendicular to the optical axis; and
an image display inverting mechanism that inverts the image based on a signal of the sensor such that an orientation of a projected image of the projection surface is set in the first position and the second position in line with the switching of the second optical system between the first position and the second position.

13. The projector according to claim 12,
wherein the projection lens is attached to the casing so as to be attachable and detachable.

14. The projector according to claim 11 further comprising:
a light source that illuminates the image forming panel;
a casing that accommodates the image forming panel in a state in which one of the image forming panel and the projection lens is shifted in a direction perpendicular to the optical axis; and
an image display inverting mechanism that inverts the image based on a signal of the sensor such that an orientation of a projected image of the projection surface is set in the first position and the second position in line with the switching of the second optical system between the first position and the second position.

15. The projector according to claim 14,
wherein the projection lens is attached to the casing so as to be attachable and detachable.

16. The projector according to claim 1,
wherein the projection lens projects all area of the image of the image forming panel towards upper than the third optical axis in the first position.

17. The projector according to claim 1,
wherein the projection lens further comprises a third optical system that includes an incident lens closest to the image forming panel, and
wherein a size of the image forming panel is smaller than a size of the incident lens in the direction perpendicular to the first optical axis.

18. The projector according to claim 1,
wherein the inverting mechanism includes a first flange and a second flange movably disposed on the first flange.

19. The projector according to claim 1,
wherein the emission lens emits the projection image onto the projection surface, and a diameter of the emission lens is greater than a length of the second mirror.

20. The projector according to claim 1,
wherein the inverting mechanism comprises a first flange and a second flange rotatably disposed on the first flange, one of the first flange and the second flange comprises a groove, another one of the first flange and the second flange comprises a protrusion, and the protrusion extends in a direction parallel to the second optical axis and is inserted into the groove.
